(19) United States
(12) Patent Application Publication
(10) Pub. No.: US 2025/0314101 A1
(43) Pub. Date: Oct. 9, 2025

(54) CONTAINER LOCKING DEVICE AND LATCHING ASSEMBLY

(71) Applicants: Douglas Forte, Hauppauge, NY (US); Gary Forte, Hauppauge, NY (US)

(72) Inventors: Douglas Forte, Hauppauge, NY (US); Gary Forte, Hauppauge, NY (US)

(21) Appl. No.: 18/984,137

(22) Filed: Dec. 17, 2024

Related U.S. Application Data
(60) Provisional application No. 63/613,190, filed on Dec. 21, 2023.
(60) Provisional application No. 63/551,342, filed on Feb. 8, 2024.
(60) Provisional application No. 63/666,773, filed on Jul. 2, 2024.

(51) Int. Cl. E05B 65/00; B65F 1/14

(52) U.S. Cl. CPC E05B 65/00; B65F 1/141; B65F 2210/148

(57) ABSTRACT

The present disclosure is directed to a guard locking device and latching assembly. The assembly includes a locking device attached to a guard which locking device is connectable to an attachment element on a container, such a refuse container. The latching assembly secures (and permits removal of) a latch plate to/from the crossbar on a container, bin or receptacle. The guard locking device permits removable attachment of at least one refuse container to a guard.

### CROSS REFERENCE TO RELATED APPLICATIONS

This application claims the benefit of priority to U.S. Provisional Application No. 63/613,190, filed Dec. 21, 2023, U.S. Provisional Application No. 63/551,342, filed Feb. 8, 2024, and U.S. Provisional Application No. 63/666,773, filed Jul. 2, 2024, the entire contents of each of which are incorporated herein by reference.

### BACKGROUND OF THE DISCLOSURE

Containers, such as trash or recycle bins, can be damaged by the movement of containers during servicing, by wind conditions and through impacts from various vehicles. Damage typically occurs because the containers are able to move freely when not enclosed or throughout an enclosure where one is present. As a result the containers can be easily knocked over or oriented in many different directions and their contents can escape, thereby polluting the immediate environment.

Damage can also occur if the containers or their covers are not secured in place on or to the container enclosure.

What is desired is an assembly including a device and latching assembly that can provide a way to removably attach and secure one or more containers to a container enclosure to protect one or more containers, and the enclosure itself, which are placed therein, from damage, spillage, movement, and interference with pedestrian or vehicle traffic and the immediate environment. Embodiments of the present disclosure provide products and methods that address the above and other issues.

### SUMMARY OF THE DISCLOSURE

The present disclosure is directed to a guard locking device and latching assembly. The guard locking device and latching assembly is attached to the guard and engages a container attachment element to secure a container to a guard. The guard locking device is a hook element of any serviceable shape or size and in one embodiment is substantially L-shaped, which can be secured to the guard or container enclosure and can be manufactured to accommodate and attach to a container attachment element on a container. The latching assembly comprises a latch plate and a pin assembly. The pin assembly comprises a pin, a biasing member, and a handle. The pin can be of any shape or cross section, including in one practice an elongated body such as, e.g. a cylinder. In one instance, the cylinder has a first end and a second end wherein the first end is configured to fit into a complimentary opening in the latch plate, said opening can comprise e.g. a hole or recess; the second end of the pin is attached to a handle either directly or indirectly, which handle can include any shape or style, e.g. a solid tab or a hand hold. The pin assembly comprises the pin wherein the second end is attached to the handle; and a biasing member which is configured to and disposed relative to the pin so as to urge the first end of the pin into the opening in a first position, which first position locks the latch plate to the crossbar thus preventing removal of the container. In one practice, the biasing member can be of any type known in the art and can be either attached to the pin directly or indirectly, or it can be positioned relative to the pin such that it provides the urge necessary to achieve the first position. In one practice, the biasing member can comprise a spring such as a coil spring through which the pin is disposed to form a spring-loaded pin. In one practice, the latch plate is unlocked by displacing the pin to a second position whereby the first end of the pin is moved out of the opening sufficient to permit the latch plate to be pivoted away from the cross bar and permit removal of the container. In a practice wherein a spring-loaded pin is utilized, the second position is obtained by applying force to the handle in a direction substantially opposite the crossbar which causes the axial displacement of the pin toward the handle and removal of the first end from the opening. The latch plate is pivotable at pivotally secured portions about the pivot axis away from and toward the crossbar. The latching assembly is secured to the guard via the locking mount.

The container guard itself includes a left side extension operably connected to a left segment, the left segment operably connected to a left corner, the left corner operably connected to a middle segment, the middle segment operably connected to a right corner, the right corner operably connected to a right segment, the right segment operably connected to a right extension, wherein each of the left segment, the middle segment and the right segment comprise at least one support maintaining a distance of each of the left segment, the middle segment and the right segment from a supporting surface, and wherein the left segment, the middle segment and the right segment are configured to form a first opening, the first opening so dimensioned and configured as to accept insertion of a first container. The guard may accommodate one or more containers which can be connected to and secured onto the guard to prevent or reduce movement of the one or more containers.

### BRIEF DESCRIPTION OF THE DRAWINGS

The present disclosure will be better understood by reference to the following drawings of which:

FIG. 1 is a side view of the guard locking device;

FIG. 2 is a perspective view of an embodiment of a guard, together with six containers attached to the guard by six guard locking devices;

FIG. 3 is a sideview of the guard locking device attached to the guard;

FIG. 4 is a top view of four guard locking device detached from the crossbar on four containers;

FIG. 5 is an enlarged view of the guard locking device in communication with a crossbar on a container;

FIG. 6 is a side view of a locking mount attached to a portion of the guard;

FIG. 7 is a top view of a tie-down member connected to a locking mount attached to a portion of the guard.

FIG. 8 is a side view of the latching assembly attached to the guard and securing the latch plate to the crossbar.

FIG. 9 is a front view of the latching assembly.

FIG. 10 is top perspective view of the latch plate hasp and hasp hole without securement device shown.

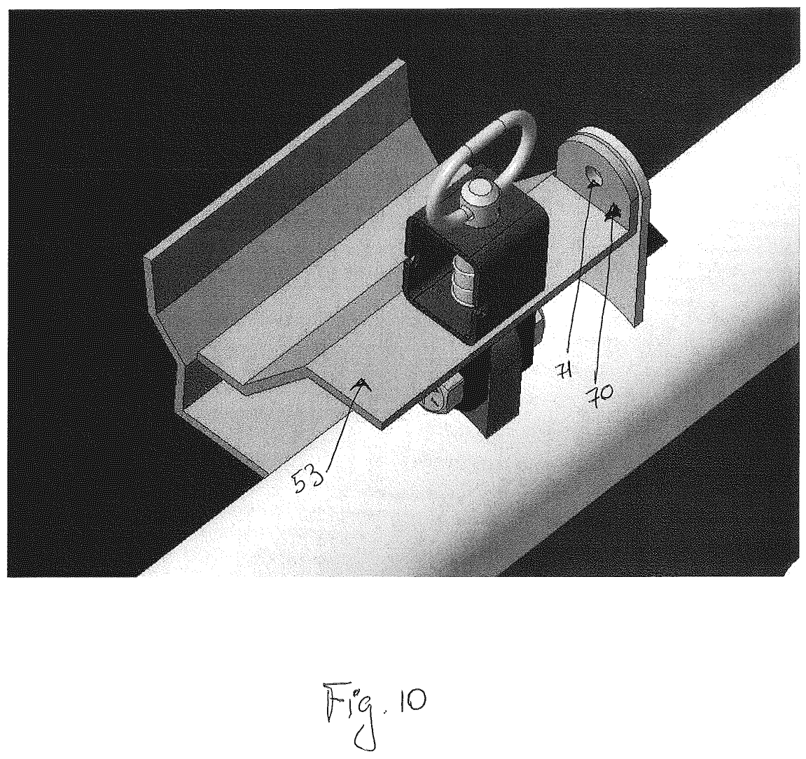

FIG. 11 is a top perspective view of the vertical plate with hole corresponding to the hole on the hasp with buttress affixed to the vertical plate. The buttress contains a hole to hold a securement device. The vertical plate and buttress are affixed to part of the guard.

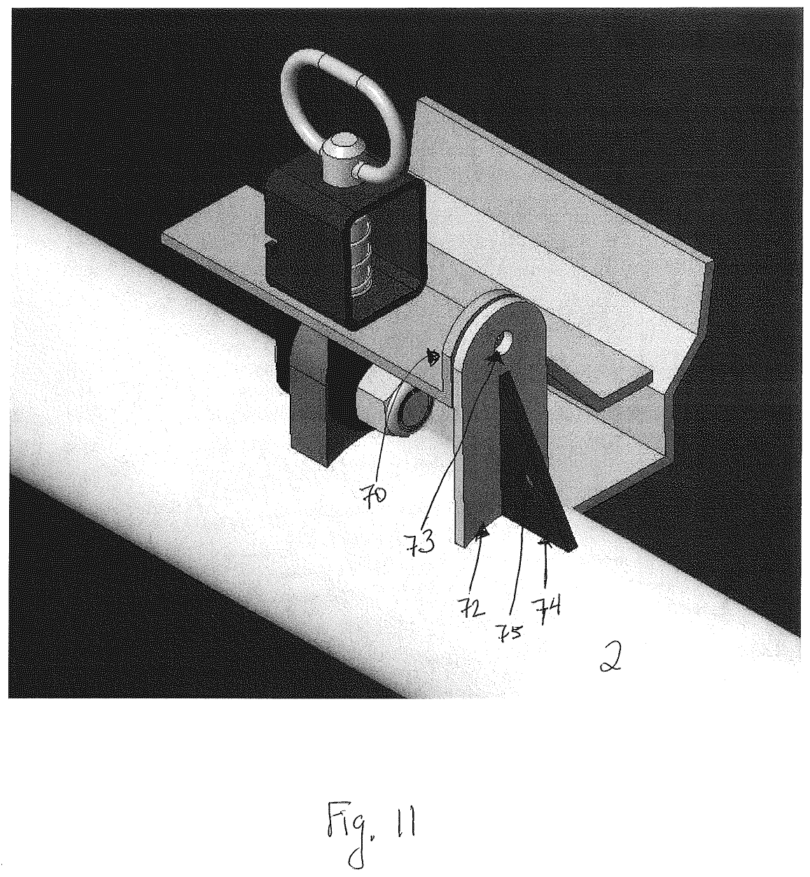

FIG. 12 is a top perspective view of the latch plate, hasp, vertical plate and buttress, together with a securement device.

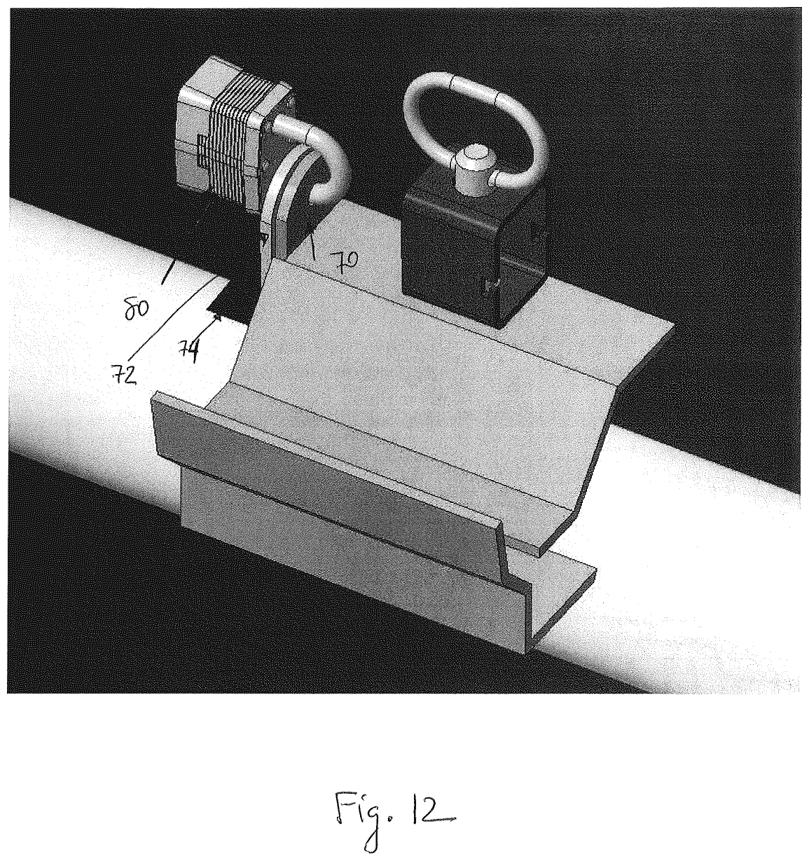

### DETAILED DESCRIPTION OF THE DISCLOSURE

The present application will now be described in greater detail by referring to the following discussion and drawings that accompany the present application. It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

It will be understood that when an element as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “beneath” or “under” another element, it can be directly beneath or under the other element, or intervening elements may be present. In contrast, when an element is referred to as being “directly beneath” or “directly under” another element, there are no intervening elements present.

In the discussion and claims herein, the term “about” indicates that the value listed may be somewhat altered, as long as the alteration does not result in nonconformance of the process or structure to the illustrated embodiment. For example, for some elements the term “about” can refer to a variation of ±0.1%, for other elements, the term “about” can refer to a variation of ±1% or ±10% or ±1°, or any point therein.

As used herein, the term “substantially”, or “substantial”, is equally applicable when used in a negative connotation to refer to the complete or near complete lack of an action, characteristic, property, state, structure, item, or result. For example, a surface that is “substantially” flat would either be completely flat, or so nearly flat that the effect would be the same as if it were completely flat.

As used herein terms such as “a”, “an” and “the” are not intended to refer to only a singular entity but include the general class of which a specific example may be used for illustration.

As used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc. In yet another illustration, reference herein to a range of from “5 to 10” includes whole numbers of 5, 6, 7, 8, 9, and 10, and fractional numbers 5.1, 5.2, 5.3, 5.4, 5.5, 5.6, 5.7, 5.8, 5.9, etc.

As used herein the term “tubular” refers to an elongate article having an internal chamber running substantially along the length thereof. In some embodiments the internal chamber is open or substantially open, such that the tubular element is substantially hollow. In some embodiments, the internal chamber is filled, or substantially filled, such that the tubular element is substantially solid.

While it is expected that the tubular elements of the present disclosure can have a substantially circular cross-sectional configuration, it is contemplated that other cross-sectional configurations, such as substantially triangular, substantially rectangular, substantially pentagonal (including other geometric shapes with 6, 7 or more sides) and substantially ellipsoidal or erratic shapes, may also be used.

As used herein the term “container” refers to any refuse and/or recycling receptacle, such as a dumpster, can, canister, tote, toter and/or bin of any volume from about 50 gallons to about 40 yards, also including the non-limiting list of example volumes: 2 yards, 4 yards, 6 yards, 8 yards, 10 yards, 15 yards, 20 yards, 25 yards and 30 yards. The container of this disclosure can be any suitable shape, including a substantially rectangular cross-section, and can include a flat and/or slanted covering extending over a portion of or the whole top of the container.

The container of this disclosure can include an “attachment element”. The term “attachment element’ refers to a crossbar positioned on the front, back or side of a container. The attachment element positioned on the container will mate with, secure to, interact with, communicate with and/or connect with a hook element which can be substantially L-shaped and can be secured to the rear portion of the container guard. The attachment element on the container can be any suitable shape, including a substantially cylindrical, substantially rectangular, substantially tubular, substantially triangular, substantially pentagonal (including other geometric shapes with 6, 7 or more sides) and substantially ellipsoidal or erratic shaped.

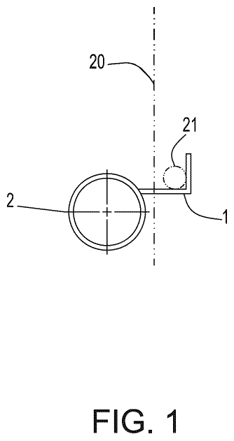

One embodiment of a guard locking device 1 for a container 20 is shown in FIG. 1.

The “guard locking device” 1 refers to a hook element. The hook element can be curved or angular (“L-shaped”) or curvilinear adequate to fit under a crossbar 21 of a container 20. The hook element or guard locking device is attached to the three sided container guard, middle segment which can accommodate one, two, three, four, five, six, seven, eight or more hook elements allowing for corresponding attachment to one, two, three, four, five, six, seven, eight or more containers 20 for securing or attaching one or more containers 20 to the guard 2 thereby restricting or preventing movement of one or more containers 20 when attached to the guard 2., The guard 2 can include a left segment 3 operably connected to a middle segment 4 and the middle segment 4 operably connected to a right segment 5.

Each of the left segment 3 middle segment 4 and right segment 5 can be formed of the same, or different materials, including plastic, metal (including steel, aluminum, iron and mixtures thereof), rubber, carbon-based materials, and mixtures thereof. Each of the left segment 3, middle segment 4 and right segment 5 can be the same, or different diameters or circumferences, ranging from about 0.5″ diameter, to about 6″ diameter or larger, also including the non-limiting list of example diameters: 1″, 1.5″, 2″, 2.5″, 3″ 3.5″, 4″, 4.5″, 5″ and 5.5″.

Operably connected to one end of the left segment 3 is left side extension 8. Left side extension 8 is at an angle relative to left segment 3, the angle being in the range of about 30° to about 60°, or about 40° to about 50°, or about 45°. Similarly, operably connected to one end of the right segment 5 is right side extension 10. Right side extension 10 is at an angle relative to right segment 5, the angle being in the range of about 30° to about 60°, or about 40° to about 50°, or about 45°.

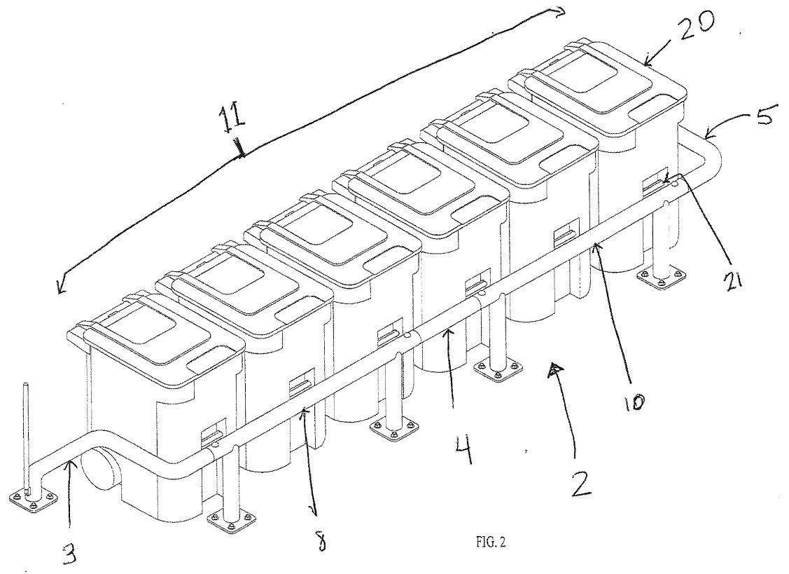

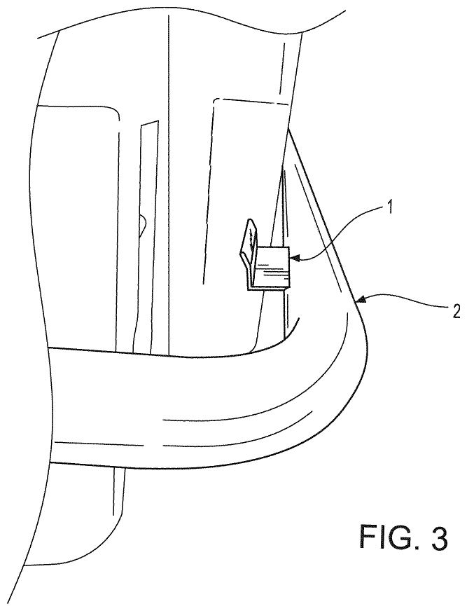

In this embodiment left side extension 8, left segment 3, middle segment 4, right segment 5 and right extension 10 can be formed of a single length of material, or two or more pieces of material joined together. Also, left side extension 8, left segment 3, middle segment 4, right segment 5 and right extension 10 form an opening 11 that is so dimensioned and configured as to accept insertion of one or more containers (shown in FIG. 2), holding and maintaining the one or more containers within the opening formed by the guard 2. Operably connected to the middle segment 4 of the guard 2 is one or more hook elements 1. (shown in FIG. 3). The hook element of the present disclosure can be substantially L-shaped and can have an angle of about 80°, 81°, 82°, 83°, 84°, 85°, 86°, 87°, 88°, 89°, 90°, 91°, 92°, 93°, 94°, 95°, 96°, 97°, 98°, 99° or 100°. In a preferred embodiment the hook element of the present disclosure has an angle of about 88°-92°. In a further preferred embodiment, the hook element of the present disclosure has an angle of about 89°-91°. In yet another preferred embodiment, the hook element of the present disclosure has an angle of 90°.

The hook element 1 of the present disclosure is operably attached to the guard 2, middle segment 4 in any suitable way, such as by welding, bolting, screw fitting and the like. Further details of the guard 2 are disclosed in U.S. Pat. No. 11,035,125, which disclosure is incorporated herein in its entirety.

The hook element 1 of the present disclosure can be fabricated from any material capable of being welded, bolted, adhered to or screwed into or onto the guard 2. The hook element 1 can be fabricated from any suitable metal substance such as steel, iron or aluminum or mixtures thereof. In an alternative embodiment, the hook element 1 can be fabricated from plastic, rubber, graphite, carbon and composite materials. In a preferred embodiment, the hook element 1 is fabricated from steel.

Operably connected to one or more containers 20 is an attachment element or “crossbar” 21, wherein the attachment element 21 is located or positioned on the rear surface of said container 20. The attachment element 21 may be of any suitable shape. In a preferred embodiment the attachment element 21 is cylindrical. In operation, one or more containers 20 is connected to the guard 2 by way of the hook element 1.

In one embodiment, the container attachment element 21 is attachable to the hook element 1 by tilting said one or more containers 20 onto the hook element 1. Similarly, the attachment element 21 is detachable from the hook element 1 by tilting one or more containers 20 away from the hook element 1.

In another embodiment, the container attachment element 21 is attachable to the hook element 1 by lifting one or more containers 20 onto the hook element 1. Similarly, the attachment element 21 is detachable from the hook element 1 by lifting one or more containers 20 away from the hook element 1.

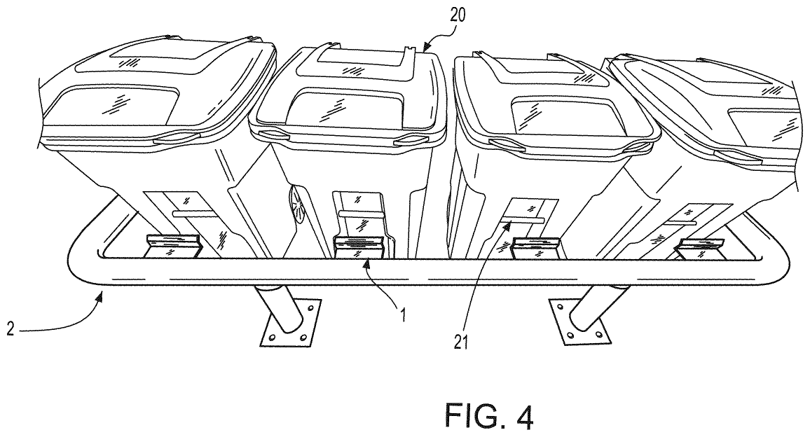

The guard 2 is substantially three sided, with an opening between two of the sides allowing for entry and removal of one or more containers 20. The guard 2, including hook element 1 can be integrally formed or the hook element 1 can be welded, adhered or positioned on the guard on the interior portion of middle segment 4 and/or expansion segments 8 and 10 such that the hook element extends inward from the interior portion of the middle segment 4 and/or expansion segments 8 and 10 as shown in FIGS. 3-5.

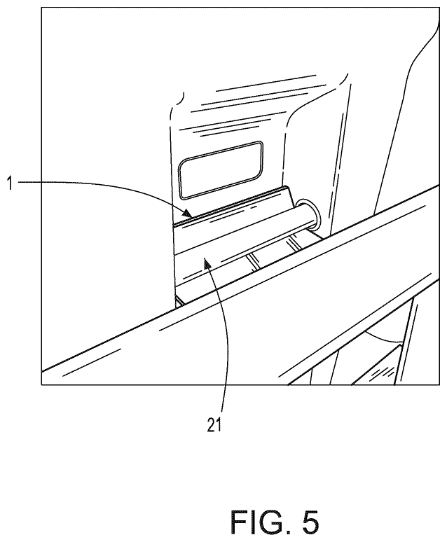

The guard 2, hook element 1 and container 20 when connected to the hook element 1 via the crossbar 21 can form an assembly. When the container 20 is attached to the guard 1 via the hook element 1, the container's freedom of movement is restricted and generally prevented due to the interaction of the attachment element 21 and the hook element 1. In an embodiment a steel hook element interconnects with a container 20 when the container 20 attachment element 21 is placed in contact with the hook element 1, thereby creating a locking configuration (See FIGS. 2 and 5). In the locked configuration, the assembly substantially or completely prevents movement of the container 20. In operation, the container 20 is secured in place until it is lifted, tilted or otherwise separated from the hook element 1. In one example, in the locked configuration, the container 20 will remain in place, attached to the hook element 1 and within the guard 2 in wind conditions, including sustained winds and winds gusts over about 5, 10, 20, 30, 40, 50, 60, 70, 80, 90 and about 100 mph.

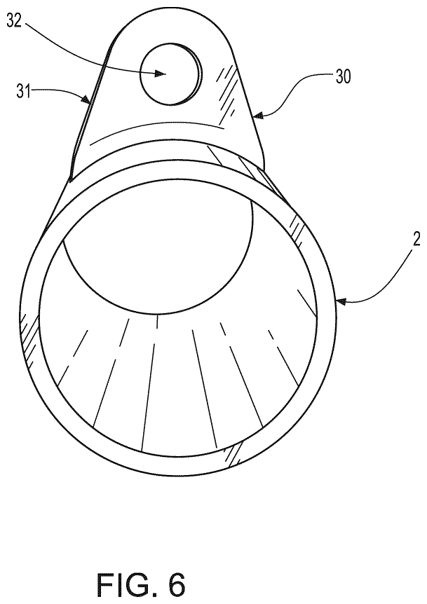

In another embodiment, one or more locking mounts 30 can be attached to the guard 2 (FIG. 6) The locking mount 30 comprises an outwardly extending plate 31 having an opening or hole therethrough 32, the hole configured to receive one or more tie-down members 33 such as a chain, flexible cord (e.g. bungee cord), rope, or other means to further secure the container 20 to the guard 2 and also prevent the lid of the container 20 from opening during windy conditions. The locking mount 30 can be fabricated from steel, iron, aluminum, plastic, rubber, graphite, carbon and composite materials. The locking mount 30 can be welded, bolted, adhered to or screwed into or onto the guard 2.

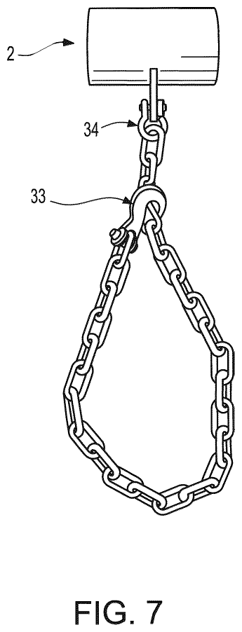

In one embodiment the tie-down member 33 can include a coupling element 34 (See FIG. 7) which is secured to the locking mount 30 via the opening 32 on the locking mount. In operation, a user passes the tie-down member 33 through the opening 32 on the locking mount or attaches the tie-down member 33 to the locking mount 30 while the other end of the tie-down member 33 is attached to the container 20. In one embodiment, a first end of the tie-down member 33 attaches to locking mount 30 and a second end of tie-down member attaches to the container 20 across the top of the container 20 to secure and prevent the container lid from opening. In an alternative embodiment two or more tie-down elements 33 are secured to the locking mount 30. One of the two or more tie-down elements 33 can attach to the container 20 via the locking mount 30 to prevent the cover from opening, while a second tie-down element 33 can attach around one or more sides of the container 30 via the locking mount 30 to further secure or anchor the container 20 and prevent movement thereof.

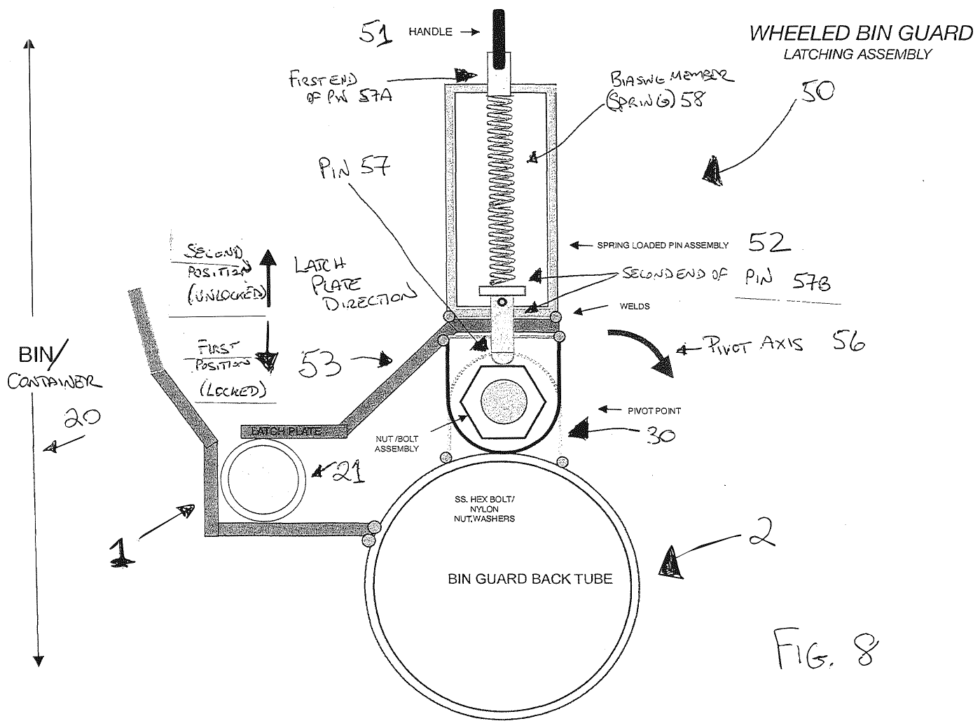

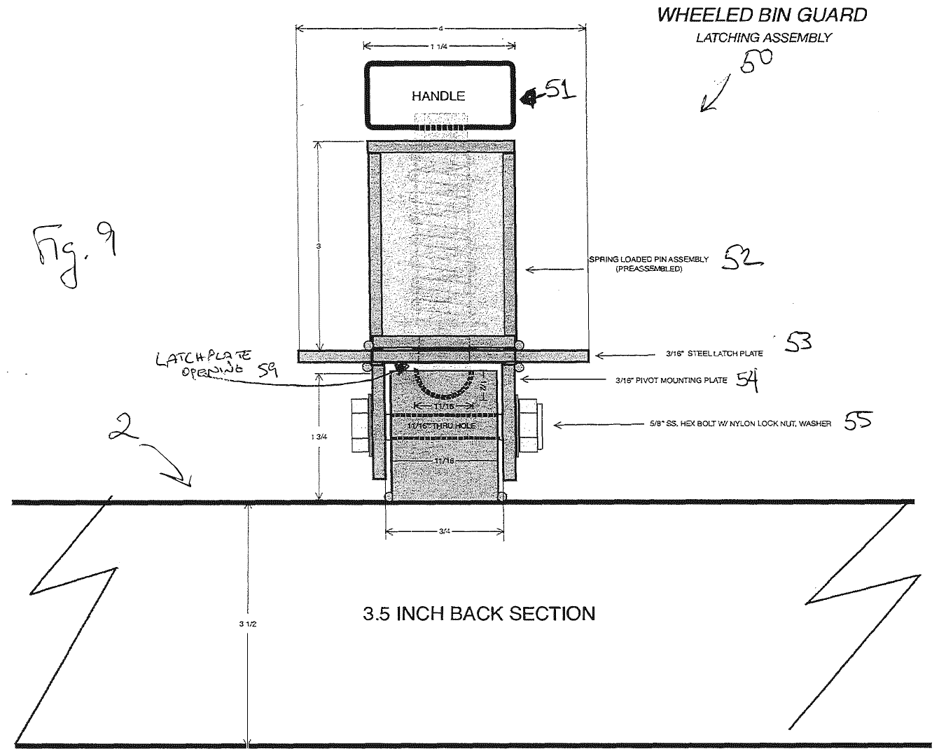

In another embodiment a latching assembly 50 can be attached to the locking mount 30. Attachment of the latching assembly 50 to the locking mount 30 can be by any conventional means including, but not limited to by nut and bolt 55 as illustrated in FIGS. 8 and 9, for example. The latching assembly 50 comprises a latch plate 53 and a pin assembly 52. The pin assembly 52 comprises (as shown in FIGS. 8 and 9) a pin 57, a biasing member (e.g. spring or coil) 58, and a handle 51. The pin 57 can be of any shape or cross-section, including in one practice an elongated body such as, e.g. a cylinder. In one instance, the cylinder has a first end and a second end wherein the first end is configured to fit into a complimentary opening 59 in the latch plate 53, said opening 59 can comprise e.g. a hole or recess; the second end of the pin is attached to a handle 51 either directly or indirectly, which handle 51 can include any shape or style, e.g. a solid tab or a hand hold. The pin assembly 52 comprises the pin 57 wherein the second end is attached to the handle 51; and a biasing member 58 which is configured to and disposed relative to the pin 57 so as to urge the first end of the pin into the opening 59 in a first position, which first position locks the latch plate to the crossbar 21 (on the container or bin 20) thus preventing removal of the container 20 and securing the container 20 in place.

In one practice, the biasing member (e.g. spring) 58 can be of any type known in the art and can be either attached to the pin 57 directly or indirectly, or it can be positioned relative to the pin 57 such that it provides the urge necessary to achieve the first position. In one practice, the biasing member 58 can comprise a spring such as a coil spring through which the pin 57 is disposed to form a spring-loaded pin (see, FIGS. 8 and 9). In one practice, the pin 57 has a first end 57A and a second end 57B. The first end of the pin 57A attaches to the handle 51 and the second end of the pin 57B is attached to the biasing member 58. In one practice, the latch plate 53 is unlocked by displacing the pin 57 to a second position whereby the second end of the pin 57B is moved out of the opening 59 sufficient to permit the latch plate 53 to be pivoted away from the crossbar 21 and permit removal of the container 20. In a practice wherein a spring-loaded pin is utilized, the second position is obtained by applying force to the handle in a direction substantially opposite the crossbar 21 which causes the axial displacement of the pin 57 toward the handle 51 and removal of the second end from the opening (see FIG. 8, up and down arrows). In accordance with the present disclosure as shown in FIG, 8, the “up” arrow represents a second position (i.e. unlocked position), and the “down” arrow represents a first position (e.g. locked). When the latch assembly 50 is in the first position, the container 20 cannot be removed from the guard 2. When the latch assembly 50 is in the second position, the crossbar 20 can be lifted from, removed from or pulled away from the hook element 1 and the container 20 can be removed from the guard 2. The latch plate 53 is pivotable at pivotally secured portions about the pivot axis 56 away from and/or toward the crossbar 21. The latching assembly 50 is secured to the guard 2 via the locking mount 30.

In a further embodiment, the latching assembly 50 comprises a mounting plate 54 which is attachable to the locking mount 30 by conventional means including nut, bolt and washer connection 55. In one practice, one or more latching assemblies 50 are present on a part of the guard 2. In a preferred practice two or more latching assemblies 50 are present on a part of the guard 2. In a preferred practice three or more latching assemblies 50 are present on a part of the guard 2. In a preferred practice four or more latching assemblies 50 are present on a part of the guard 2.

In a further embodiment latch plate 53 can include a fastener, including hinged fasteners

such as without limitation hasp 70, which may have an angle of about 80°, 81°, 82°, 83°, 84°, 85°, 86°, 87°, 88°, 89°, 90°, 91°, 92°, 93°, 94°, 95°, 96°, 97°, 98°, 99° or 100°. Preferably, in the non-limiting embodiment shown, the hasp 70 is formed at a 90° angle relative to the latch plate 53 and is located on one or both ends of the latch plate 53. The hasp 70 can have one or more holes 71 through which one or more securement members, including one or more locks 80, such as a padlock or combination lock fit. In the embodiment shown, adjacent to the hasp 70 is a substantially vertical plate 72 that contains a hole 75 corresponding to the location of the hole 71 in the hasp 70. The vertical plate 72 is affixed to or part of the guard 2. The vertical plate 72 can have a supporting structure, such as buttress, 74 which acts to stabilize and support the vertical plate 72. The supporting structure 74 can also have one or more holes 75 that can be used to hold one or more locks 80 such as a padlock or combination lock. The hole 71 on the hasp and the vertical plate hole 73 are aligned to permit the insertion of a lock 80 therethrough to secure the bin or container 20 to the guard 2 and ensure that bin or container 20 is not removed from the guard 2.

In a further embodiment latch plate 53 can include two hasps 70, e.g. one on each end of latch plate 53. In this practice a second substantially vertical plate 72 can be affixed to or be a part of guard 2 along with supporting structure 74. If two hasps 70 are present, then two securement devices, e.g. lock 80 (not shown) may be used to further secure the container 20 to part of the guard 2.

The described embodiments and examples of the present disclosure are intended to be illustrative rather than restrictive and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

1. A guard locking and latching device comprising:
one or more hook elements operably connected to a rear surface of a guard comprising a left side extension operably connected to a left segment;
the left segment operably connected to a left corner;
the left corner operably connected to a middle segment;
the middle segment operably connected to a right corner;
the right corner operably connected to a right segment;
the right segment operably connected to a right extension,
wherein each of the left segment, the middle segment and the right segment comprise at least one support maintaining a distance of each of the left segment, the middle segment and the right segment from a supporting surface;
wherein the left segment, the middle segment and the right segment are configured to form a first opening, the first opening so dimensioned and configured as to accept insertion of one or more containers wherein said one or more containers attaches to said one or more hook elements at an attachment element positioned on the one or more containers and a latching assembly.

2. The guard locking and latching device of claim 1, wherein the left side extension and the right side extension of said guard contact the supporting surface.

3. The guard locking and latching device of claim 1, wherein each of the left segment, the middle segment and the right segment of said guard comprise at least two supports maintaining a distance of each of the left segment, the middle segment and the right segment from the supporting surface.

4. The guard locking and latching device of claim 1, wherein the device is a hook element having an angle of about 80°, 81°, 82°, 83°, 84°, 85°, 86°, 87°, 88°, 89°, 90°, 91°, 92°, 93°, 94°, 95°, 96°, 97°, 98°, 99° or 100°.

5. The guard locking and latching device of claim 1, wherein the guard further comprises an expansion middle segment operably connected to the right corner, the expansion middle segment operably connected to an expansion corner, the expansion corner operably connected to an expansion right segment, the expansion right segment operably connected to an expansion right side extension, wherein the right segment, the expansion middle segment and the expansion right segment are configured to form a second opening, the second opening so dimensioned and configured as to accept insertion of a second container, wherein at least one guard locking device is operably connected to said expansion middle segment.

6. The guard locking and latching device of claim 4, wherein the device has an angle of about 90°.

7. The guard locking and latching device of claim 1, wherein said device is fabricated from a substance selected from the group consisting of steel, iron, aluminum, plastic, rubber, graphite, carbon and composite materials.

8. The guard locking and latching device of claim 1, wherein the attachment element is located on the rear surface of said container.

9. The guard locking and latching device of claim 1, wherein the attachment element located on the rear surface of said container is cylindrical.

10. The guard locking and latching device of claim 1, wherein said attachment element is attachable to said guard locking device by tilting said one or more containers onto said guard locking device.

11. The guard locking and latching device of claim 1, wherein said attachment element is detachable from said guard locking device by tilting said one or more containers away from said guard locking device.

12. The guard locking and latching device of claim 1, wherein said attachment element is attachable to said guard locking device by lifting said one or more containers onto said guard locking device at the attachment element.

13. The guard locking and latching device of claim 1, wherein said attachment element is detachable from said guard locking device by lifting said one or more containers away from said guard locking device at the attachment element.

14. The guard locking and latching device of claim 1, further comprising a locking mount.

15. The guard locking and latching device of claim 14, wherein said locking mount comprises a hole.

16. The guard locking and latching device of claim 15, wherein the locking mount hole accommodates a tie-down member.

17. The guard locking and latching device of claim 1, comprising a pin assembly.

18. The guard locking and latching device of claim 17, wherein said pin assembly comprises a pin, a biasing member, and a handle.

19. The guard locking and latching device of claim 18, wherein said biasing member is a coil spring.

20. The guard locking and latching device of claim, 1 further comprising a latch plate.

21. The latch plate of claim 20, further comprising one or more hinged fasteners.

22. The latch plate of claim 21, wherein said one or more hinged fasteners is a hasp.
